(19) United States
(12) Patent Application Publication
(10) Pub. No.: US 2015/0256730 A1
(43) Pub. Date: Sep. 10, 2015

(54) IMAGE-CAPTURING DEVICE CONFIGURED FOR A HANDHELD ELECTRONIC DEVICE

(71) Applicant: FORWARD OPTICS CO., LTD., Taichung City (TW)

(72) Inventors: Wei Shen, Taichung City (TW); Yuan-Lin Lee, Taichung City (TW)

(73) Assignee: FORWARD OPTICS CO., LTD., Taichung City (TW)

(21) Appl. No.: 14/198,057

(22) Filed: Mar. 5, 2014

(51) Int. Cl. H04N 5/225; H04N 5/232

(52) U.S. Cl. CPC H04N 5/2257; H04N 5/23216; H04N 5/2252; H04N 5/2258

(57) ABSTRACT

An image-capturing device configured for a handheld electronic device includes a protective case and an image-capturing module having a first transmission unit. The protective case has a receiving space and an opening. The image-capturing module is disposed in the protective case, and includes a camera unit, a processing unit, and a second transmission unit. In response to user commands inputted through the handheld electronic device and communicated to the image-capturing device via the communication established between the first transmission unit and the second transmission unit, the processing unit is operable to control operation of the camera unit.

### BACKGROUND OF THE INVENTION

1. Field of the Invention

The present invention relates to an image-capturing device configured for a handheld electronic device.

2. Description of the Related Art

Handheld electronic devices are becoming a necessity in our daily lives. Cameras have become essential as they are required for photo and video sharing and video conferencing. The density of electronic components in a handheld electronic device is increasing in order to reduce dimensions and weight and improve processing speed and functionality. Camera resolution for handheld electronic devices has reached as high as 4 mega pixels. However, a camera having a high resolution (such as resolution higher than 13 mega pixels) requires more room for accommodating the increased number of optical lenses, thus increasing the thickness of the handheld electronic device that implements the high resolution camera. Therefore, handheld electronic devices do not usually come with cameras having a resolution higher than 1 mega pixels except for the high end ones. As a result, users of ordinary and even obsolete handheld electronic devices cannot enjoy the benefits of high resolution cameras.

In the prior art, optical lenses, camera flash, shutter, batteries, etc. are added to the handheld electronic devices as accessories for improving upon the cameras on the handheld electronic devices, such as the user experience and the picture quality. Taiwanese Patent Publication no. M438084 discloses an accessory having refraction lenses that change the angle of shooting for enabling one to shoot an object without directly aiming at it. Taiwanese Patent Publication nos. M429296, M433575, and M456515 disclose additional lenses with mechanical elements and lens module with connecting elements that are able to change a focal length of the lens of the camera on the handheld electronic device that is installed with the additional lenses or the lens module.

The quality and the precision of the optical lenses in the camera must be high in order to result in high quality images. For the case of a 5 mega pixels camera, the tolerance for space between optical lenses and the center offset must be controlled to be within +/−0.005 mm. In comparison, there is a lack of precision in the alignment between the aforementioned additional lenses and the camera or the lens module and the camera. Furthermore, the optical design may not be compatible with different cameras on a wide range of handheld electronic devices.

### SUMMARY OF THE INVENTION

The object of the present invention is to provide an image-capturing device configured for a handheld electronic device.

According to this invention, an image-capturing device is configured for a handheld electronic device. The handheld electronic device includes a first camera unit that has a first lens and a first image sensor operatively associated with the first lens, a first processing unit electrically coupled with the first camera unit, a first transmission unit electrically coupled with the first processing unit, an operation interface for inputting user commands to the first processing unit, and a display interface electrically coupled with the first processing unit.

The image-capturing device includes a protective case and an image-capturing module. The protective case has a receiving space for receiving the handheld electronic device, and an opening disposed to correspond in position with the first lens of the first camera unit of the handheld electronic device when the handheld electronic device is received in the receiving space. The image-capturing module is disposed in the protective case. The image-capturing module includes a second camera unit that is spaced apart from the opening and that has a second lens and a second image sensor operatively associated with the second lens, a second processing unit electrically coupled with the second camera unit, and a second transmission unit electrically coupled with the second processing unit and operable to establish communication with the first transmission unit of the handheld electronic device.

The second processing unit is operable to communicate with the first processing unit of the handheld electronic device via the first transmission unit and the second transmission unit, is operable to control operation of the second camera unit in response to the user commands inputted through the operation interface and communicated by the first processing unit to the second processing unit, and is operable to communicate image data generated by the second camera unit to the first processing unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of an image-capturing device according to a preferred embodiment of the present invention;

FIG. 2 is a perspective view illustrating the image-capturing device being installed on a handheld electronic device;

FIG. 3 is a schematic circuit block diagram illustrating the connections between the image-capturing device and the handheld electronic device; and

FIG. 4 is a perspective view of a second camera unit of the image-capturing device having an array of second lenses and an array of second image sensors.

### DETAILED DESCRIPTION OF THE PREFERRED EMBODIMENT

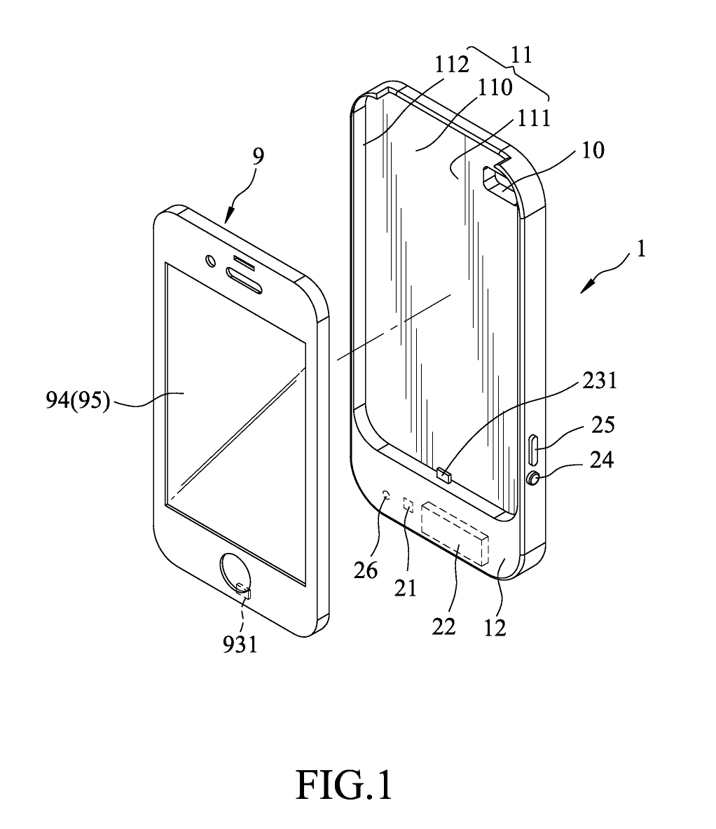

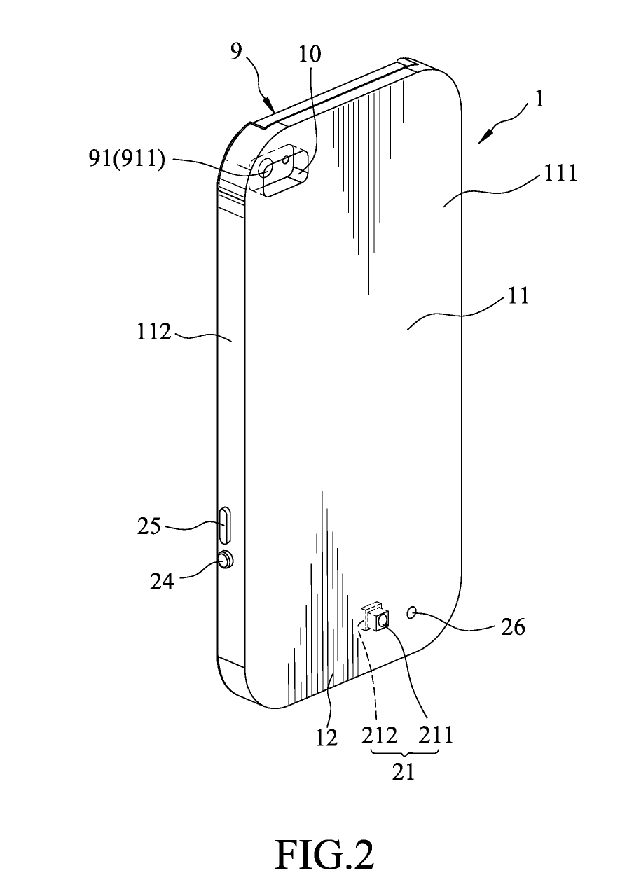

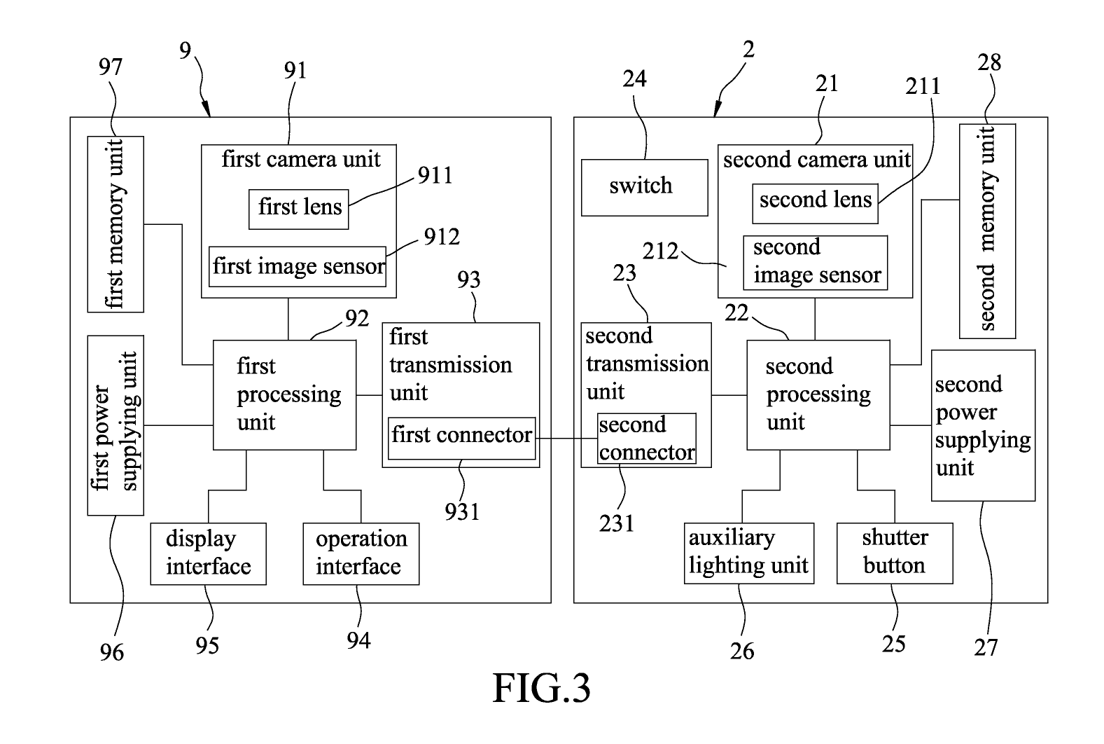

Referring to FIGS. 1, 2 and 3, the preferred embodiment of an image-capturing device according to this invention is configured for a handheld electronic device 9.

The handheld electronic device 9 includes a first camera unit 91 that has a first lens 911 and a first image sensor 912 operatively associated with the first lens 911, a first processing unit 92 electrically coupled with the first camera unit 91, a first transmission unit 93 electrically coupled with the first processing unit 92 and having a first connector 931, an operation interface 94 for inputting user commands to the first processing unit 92, a display interface 95 electrically coupled with the first processing unit 92, a first power supplying unit 96 electrically coupled with the first processing unit 92, and a first memory unit 97 electrically coupled with the first processing unit 92. In this preferred embodiment, the operation interface 94 and the display interface 95 are realized using a touch screen of the handheld electronic device 9. The image-capturing device includes a protective case 1 and an image-capturing module 2.

The protective case 1 has a cover portion 11, and an extension portion 12 that extends from a periphery of a bottom side of the cover portion 11 and that is co-planar and disposed side-by-side with the cover portion 11. In other embodiments, the extension portion 12 extends from other parts of the periphery of the cover portion 11, i.e., the top, left or right side of the cover portion 11. The cover portion 11 has a base wall 111 and a surrounding wall 112 surrounding the base wall 111. The base wall 111 and the surrounding wall 112 cooperatively define a receiving space 110 for receiving the handheld electronic device 9. The base wall 111 is formed with an opening 10 disposed to correspond in position with the first lens 911 of the first camera unit 91 of the handheld electronic device 9 when the latter is received in the receiving space 110. A thickness of the extension portion 12 is larger than thickness of the base wall 111. Moreover, boundaries of the extension portion 12 with the cover portion 11 are smooth.

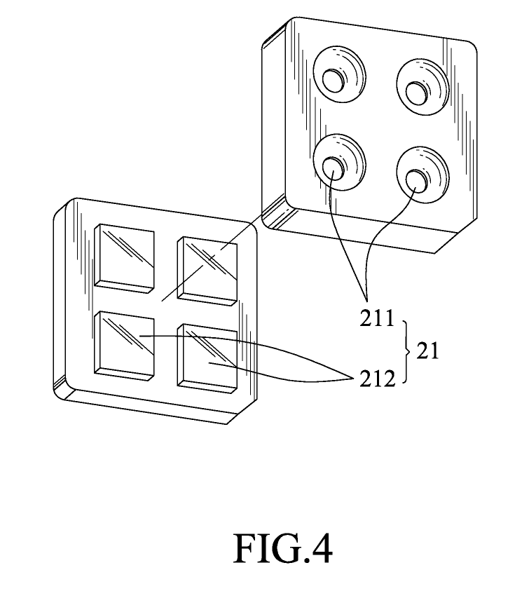

The image-capturing module 2 is disposed in the protective case 1. The image-capturing module 2 includes a second camera unit 21 that is spaced apart from the opening 10, a second processing unit 22 electrically coupled with the second camera unit 21, and a second transmission unit 23 electrically coupled with the second processing unit 22 and operable to establish communication with the first transmission unit 93 of the handheld electronic device 9. The second transmission unit 23 has a second connector 231 exposed to the receiving space 110. The image-capturing module 2 further includes a switch 24 electrically coupled with the second transmission unit 23 and disposed on the protective case 1, a shutter button 25 electrically coupled with the second processing unit 22 and disposed on the protective case 1, an auxiliary lighting unit 26 electrically coupled with the second processing unit 22 and disposed on the protective case 1, a second power supplying unit 27 electrically coupled with the second processing unit 22, and a second memory unit 28 electrically coupled with the second processing unit 22. The shutter button 25 is operable to trigger the second processing unit 22 so as to control the second camera unit 21 to capture an image and so as to store image data generated by the second camera unit 21 in the memory unit 28. The second camera unit 21 has a second lens 211 on a side of the protective case 1 that is opposite to the receiving space 110, and a second image sensor 212 operatively associated with the second lens 211 and disposed at an image side of the second lens 211. The second camera unit 21 is disposed in the extension portion 12, and the second lens 211 of the second camera unit 21 is disposed outwardly with respect to the receiving space 110. Preferably, the second camera unit 21 includes an array of four second lenses 211 and an array of four second image sensors 212 as best (shown in FIG. 4). Each of the second image sensors 212 is positioned at an image side of a respective one of the second lenses 211. The second camera unit 21 is able to capture a high quality image by having the image sensors 212 arranged in an array, rather than in a stack, that reduces the thickness of the second camera unit 21. In this preferred embodiment, the image quality of the image captured by the second camera unit 21 is higher than that captured by the first camera unit 91, and has a pixel resolution of at least 8 mega pixels.

When the handheld electronic device 9 is received in the receiving space 110 of the protective case 1, the first connector 931 and the second connector 231 are electrically coupled such that the second transmission unit 23 electrically coupled with the second processing unit 22 is operable to establish communication with the first transmission unit 93 of the handheld electronic device 9. The switch 24 is operable to activate the second transmission unit 23 for enabling establishment of communication between the second transmission unit 23 of the image-capturing module 2 and the first transmission unit 93 of the handheld electronic device 9, such that the second processing unit 22 is operable to communicate with the first processing unit 92 of the handheld electronic device 9 via the first transmission unit 93 and the second transmission unit 23. The second processing unit 22 is operable to control operation of the second camera unit 21 in response to the user commands inputted through the operation interface 94 and communicated by the first processing unit 92 to the second processing unit 22, and is operable to communicate image data generated by the second camera unit 21 to the first processing unit 92. Images captured by the second camera unit 21 may then be displayed on the display interface 95 of the handheld electronic device 9. In other embodiments, the communication established between the second transmission unit 23 and the first transmission unit 93 can be, for instances, based on Bluetooth, wireless fidelity or near field communication techniques. The data of the image captured by the second camera unit 21 is first compressed and processed by the first processing unit 92 and the second processing unit 22, and then stored in the first memory unit 97 of the handheld electronic device 9. In a low light environment, the auxiliary lighting unit 26 provides auxiliary light to aid the second camera unit 21 when shooting images. In addition to the operation interface 94 for controlling the second camera unit 21, the shutter button 25 can also be triggered to control the second camera unit 21 for shooting images.

The second camera unit 21 is operable to capture an image without operating the switch 24, i.e., the second camera unit 21 can be operated through the shutter button 25 for image capturing, and the captured image is then compressed into an image data which is saved in the second memory unit 28.

In this preferred embodiment, the second lens 211 of the second camera unit 21 is positioned as a rear-facing camera of the handheld electronic device 9. However, in other embodiments, the second lens 211 may be positioned at other positions on the cover portion 11 to suit different needs, such as front-facing or rear-facing camera. Moreover, in this embodiment, the second power supplying unit 27 can act as a power source that charges the handheld electronic device 9 through electrical coupling between the second connector 231 and the first connector 931.

Some advantages of the present invention are summarized as follows: Compared to the quality of the images captured by the first camera unit 91 of the handheld electronic device 9, the second camera unit 21 of the image-capturing module 2 can capture images of a higher quality. The image-capturing module 2 may functions independently without the need of physical or mechanical interaction with the first camera unit 91. The image-capturing device can be configured for different models of handheld electronic device 9 by modifying the shape of the protective case 1 and the application programs installed in the handheld electronic device 9. Moreover, the second camera unit 21, the second processing unit 22 and the second power supplying unit 27 are disposed in the extension portion 12 of the protective case 1 such that the image-capturing device can be reduced in thickness while housing a high quality image capturing second camera unit 21 that may have larger dimensions.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An image-capturing device configured for a handheld electronic device, the handheld electronic device including a first camera unit that has a first lens and a first image sensor operatively associated with the first lens, a first processing unit electrically coupled with the first camera unit, a first transmission unit electrically coupled with the first processing unit, an operation interface for inputting user commands to the first processing unit, and a display interface electrically coupled with the first processing unit, the image-capturing device comprising:
a protective case having a receiving space for receiving the handheld electronic device, and an opening disposed to correspond in position with the first lens of the first camera unit of the handheld electronic device when the handheld electronic device is received in the receiving space; and
an image-capturing module disposed in the protective case, the image-capturing module including a second camera unit that is spaced apart from the opening and that has a second lens and a second image sensor operatively associated with the second lens, a second processing unit electrically coupled with the second camera unit, and a second transmission unit electrically coupled with the second processing unit and operable to establish communication with the first transmission unit of the handheld electronic device;
wherein the second processing unit is operable to communicate with the first processing unit of the handheld electronic device via the first transmission unit and the second transmission unit, is operable to control operation of the second camera unit in response to the user commands inputted through the operation interface and communicated by the first processing unit to the second processing unit, and is operable to communicate image data generated by the second camera unit to the first processing unit.

2. The image-capturing device according to claim 1, wherein the protective case further has a cover portion and an extension portion that extends from a part of a periphery of the cover portion, the cover portion having a base wall and a surrounding wall surrounding the base wall, the opening being formed in the base wall, the base wall and the surrounding wall cooperatively defining the receiving space, the second camera unit being disposed in the extension portion, the second lens of the second camera unit being disposed outwardly with respect to the receiving space.

3. The image-capturing device according to claim 2, wherein the extension portion is co-planar and is disposed side-by-side with the cover portion, and a thickness of the extension portion is larger than a thickness of the base wall.

4. The image-capturing device according to claim 3, wherein boundaries of the extension portion with the cover portion are smooth.

5. The image-capturing device according to claim 1, wherein the image-capturing module further includes a switch electrically coupled with the second transmission unit and disposed on the protective case, the switch being operable to activate the second transmission unit for enabling establishment of communication between the second transmission unit and the first transmission unit.

6. The image-capturing device according to claim 1, wherein the image-capturing module further includes a power supplying unit electrically coupled with the second processing unit.

7. The image-capturing device according to claim 1, wherein the image-capturing module further includes a memory unit electrically coupled with the second processing unit.

8. The image-capturing device according to claim 7, wherein the image-capturing module further includes a shutter button electrically coupled with the second processing unit and disposed on the protective case, the shutter button being operable to trigger the second processing unit so as to control the second camera unit to capture an image and so as to store image data generated by the second camera unit in the memory unit.

9. The image-capturing device according to claim 1, wherein the image-capturing module further includes an auxiliary lighting unit electrically coupled with the second processing unit and disposed on the protective case.

10. The image-capturing device according to claim 1, wherein the second camera unit includes an array of the second lenses and an array of the second image sensors, each of the second image sensors being positioned at an image side of a respective one of the second lenses.

11. The image-capturing device according to claim 1, wherein the image data generated by the second camera unit has a pixel resolution of at least 8 mega pixels.
